(19) United States
(12) Patent Application Publication
(10) Pub. No.: US 2008/0306823 A1
(43) Pub. Date: Dec. 11, 2008

(54) ELECTRONIC PUBLICATION ADVERTISING SYSTEM

(75) Inventors: Thomas A. Doran, St. Paul, MN (US); William Dornbach, St. Paul, MN (US); John M. Ivancevich, St. Paul, MN (US); Margaret M. Morgan, St. Paul, MN (US); Edgar Laube, St. Paul, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: Textbook Media, Inc., St. Paul, MN (US)

(21) Appl. No.: 12/131,641

(22) Filed: Jun. 2, 2008

Related U.S. Application Data
(60) Provisional application No. 60/941,519, filed on Jun. 1, 2007.

(51) Int. Cl. G06Q 30/00; G06Q 90/00

(52) U.S. Cl. 705/14

(57) ABSTRACT

An electronic publication advertising system including establishing sponsorship standards for reviewing advertisements for inclusion in an electronic publication. At least one advertisement is reviewed to determine whether the at least one advertisement complies with the sponsorship standards. The electronic publication is reviewed to determine a placement location of the at least one advertisement. The electronic publication is distributed with the at least one advertisement in the placement location. The electronic publication is reviewed by a person affiliated with the use of the distributed electronic publication to determine if the at least one advertisement meets the sponsorship standards.

### REFERENCE TO RELATED APPLICATION

This application claims priority to U.S. Provisional Application No. 60/941,519, filed Jun. 1, 2007, the contents of which are hereby incorporated by reference.

### FIELD OF THE INVENTION

The invention relates generally to electronic publications. More particularly, the invention relates to an advertising system for electronic publications.

### BACKGROUND OF THE INVENTION

There are many ways in which persons can gain knowledge. A few of the most common ways in which knowledge is imparted to the person is a visual presentation, which may be live or via a video recording or broadcast. Another way in which knowledge may be imparted to a person is via text, which may be presented on paper or on a video display.

While the visual presentation may be more effective than reading text in certain situations because the visual presentation may be more entertaining, it is not always possible to utilize a video presentation. Additionally, the video presentation may be more expensive because of the production costs.

Heretofore, one of the primary mechanisms utilized to distribute text is in the form of a book. There are various factors that affect the price of books. One such factor is the cost to create the book, namely writing the text and creating the images or photographs. Another factor that affects the cost of books is the printing and distribution costs.

Academic books generally focus on a particular subject and further focus on a specific level so that the book would be at an appropriate level for the person using the book. As a result of the specialized nature of educational books, they are generally produced in smaller quantities than entertainment books. The cost of educational books generally gets progressively higher as the level of the book increases because there is a progressively smaller potential market for such books.

The relatively high cost of books that are utilized with higher level or more specialized classes may be so high such that when combined with the limited economic resources of many students taking such classes that the students may not be able to afford to purchase all of the books that are required for particular classes. When students do not have all of the books that are to be used with particular classes, the students' ability to acquire the knowledge from the class may be degraded, which may negatively impact the instructor's ability to teach the class. Additionally, when students are not able to purchase all of the assigned books, the revenue of the publishers is also decreased.

### SUMMARY OF THE INVENTION

An embodiment of the invention is directed to an electronic publication advertising system. Sponsorship standards are established for reviewing advertisements for inclusion in an electronic publication. At least one advertisement is reviewed to determine whether the at least one advertisement complies with the sponsorship standards.

The electronic publication is reviewed to determine a placement location of the at least one advertisement. The electronic publication is distributed with the at least one advertisement in the placement location. The electronic publication is reviewed by a person affiliated with the use of the distributed electronic publication to determine if the at least one advertisement meets the sponsorship standards.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a flow diagram of an electronic publication advertising system according to an embodiment of the invention.

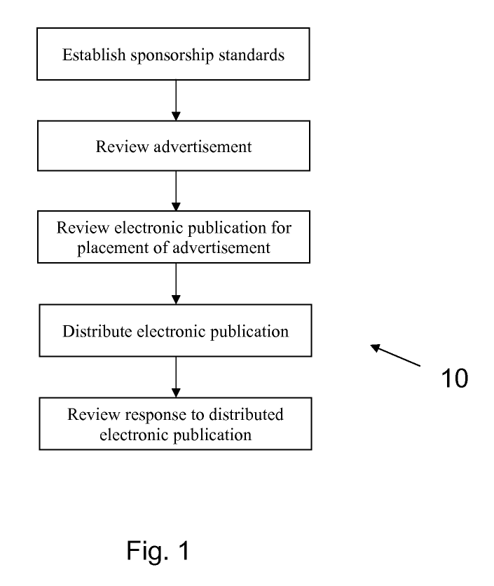

### DETAILED DESCRIPTION OF THE PREFERRED EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

An embodiment of the invention is directed to an electronic publication advertising system, as illustrated at 10 in the figure. The electronic publication may be presented in a variety of formats using the concepts of the present invention, examples of which include internet browser-based, image-based and text-based. Through the use of the electronic publication advertising system 10, it is possible for the various parties associated with the publication to benefit.

For example, when the publication is educational, students benefit by increased ability to access the educational publication because of the reduced cost when compared to traditional educational publications. Educators benefit because it is easier to teach students who have the educational publications that are recommended to be used with particular classes. Publishers benefit because the increased number of students using the educational publication increases revenue. Additionally, advertisers benefit through enhanced access the students who are often in a demographic that is difficult to reach through other advertising media.

While each of the preceding groups has the potential to benefit from the participation in the electronic publication advertising system, the benefits of the respective parties must be balanced to ensure that the intended benefits are realized by each of the parties.

A step in the electronic publication advertising system involves setting academic sponsorship standards. These standards may promote learning and learning environments. Factors that may be considered in this process include supporting diversity, gender equity, healthy behaviors, ethical conduct and academic standards. Depending on the educational institution at which the electronic publications are to be used, the factors may include additional or alternative criteria such as sexuality, morals and religion.

Other principles that may be considered is whether the advertisement enhances the overall value of higher education and whether the advertisements violate fundamental principles and specific guidelines such as causing harm to student health, safety and welfare.

The academic sponsorship standards may be set by a group such as an academic sponsorship council. The academic sponsorship council may include one or more representatives from students, educators, publishers, educational administrators, school board members and parents of the students.

The academic sponsorship standards may include guidelines on the amount, size and specific textbook real estate that is available for placement of advertisements. In this process, the desire to minimize the size, quantity and obstrusiveness must be balanced against the need of the advertisers to receive sufficient benefits from the advertisements to fund the preparation and distribution of the electronic publication.

Assessment of the academic content in a specific publication factors one or more of the following criteria when determining sponsorship real estate, academic subject matter, reading level of the academic content that may be measured by industry standards for comprehension level, use of pedagogy and art work such as tables, graphs, photos and cartoons, amount of content between section headings or chapters, length of the publication, and type and length of accompanying study aids.

Through the setting of academic sponsorship standards by the academic sponsorship council, advertisements may be approved based upon a number of factors such as whether the advertisements relate to certain approved industries or fields.

To reduce the potential burdens on participants in the academic sponsorship council, there may be only certain times during the calendar year in which advertisements are reviewed to determine whether they comply with the academic sponsorship standards.

It can be appreciated that the review to determine whether advertisements comply with the academic sponsorship standards may be conducted using a variety of mechanisms such as in-person meetings, teleconferences, web conferences and surveys.

Another factor that may be utilized in the electronic publication advertising system includes assessment of the academic content in the electronic publications. While it is possible for this step to also be performed by the academic sponsorship council, this step may also be performed by an editor or group of editors.

In certain embodiments, this assessment may be done pursuant to the academic sponsorship standards. As noted above, these factors may include writing style, reading difficulty and use of pedagogy.

Another step in the electronic publication advertising system may include marking the electronic publication with placeholders. These placeholders may identify regions of the electronic publication where advertisements may be placed as well as the type of advertisement that may be utilized, examples of which include displays, videos, coupons, games and surveys.

To further increase the value of the electronic publication advertising system, the placeholders in a particular electronic publication may be assigned a comparative value to other placeholders in the electronic publication based on their quality. Those placeholders that are assigned a higher value may command a higher advertising value than those placeholders with a lower assigned value.

The particular advertisement that is served to the coded placeholder may be driven by data that is obtained from the persons who will be using the electronic publication. More details on the process of placing advertisements in an electronic publication are set forth in copending patent application U.S. application Ser. No. 11/758,951, which is owned by the same assignee as the present application, the details of which are incorporated herein by reference.

To ensure that the electronic publication advertising system is not only complying with academic sponsorship standards but also providing a useful tool in the educational setting, the educational publications are periodically reviewed by the instructors who are utilizing the electronic publications in their classes.

Periodically, such as between semesters or terms, instructors or others affiliated with the use of the distributed electronic publication may be given the opportunity to provide feedback on the electronic publication. The instructors may review a variety of factors such as the content, placement, size and pedagogy of the advertisements. Based upon the results of this input, each of the advertisements may be assigned a rating. Sponsors with advertisements that fall below acceptable levels may have their advertisements removed from the list of approved advertisements. The sponsors may also be provided with the opportunity to revise the advertisements to overcome the objections and/or enhance the ratings.

Once an advertisement has successfully completed the preceding steps, the advertisement may receive a certification status, which enables the advertisement to continue to be included in the list of approved advertisements. To encourage the sponsors to attain the certification status, certified advertisements may be given benefits such as preferential advertising rates and/or preferential placement in the electronic publications. Sponsors may also be permitted to include a certification notice in their advertisements.

In addition to relating solely to education publications, the system described herein may be used in conjunction with other promotional activities at the educational institution, examples of these other promotional activities include sporting events, billboards, and internet sites.

Still another step in the electronic publication advertising system may relate to the collection of data relating to the responses received from the advertisements. For example, if the electronic publication is displayed in a browser that is accessible through the internet, the advertisements may be a link that is accessed by clicking on the advertisement.

The data collection system may compile information about the number of times the advertisement was accessed and such data may be correlated to other information provided by the user of the electronic publication. In certain circumstances, information about particular users may not be accessible but rather information from particular users will be compiled such that the information does not identify individual users but only the groups of which the user is a member such as a class, school, school district, city, state, region or country.

Evaluating such data could be used to further enhance the value of the advertisements to the advertiser, which thereby may increase the revenue that is received by the publishers.

Even though the concepts of the invention are described for use in conjunction with electronic publications, it is also possible to adapt the concepts for use with printed publications. While it is possible to customize printed publications for individual students, it may be more cost effective to select the advertisements based upon one or more of the following criteria—students in a particular class, school, school district, city, state, region or country.

As an alternative to printing a single printed publication that is used through a term, semester or school year, separating the printed publication into sections such as chapters, units or modules would enable periodic revision of the advertisements placed therein to thereby increase the value of the advertisements to the advertisers and consequently enable the publishers to receive greater revenue.

The process for filtering and placing advertisements that is described above with respect to electronic publications may also be utilized with respect to the placement of advertisements in printed publications.

It is contemplated that features disclosed in this application, as well as those described in the above applications incorporated by reference, can be mixed and matched to suit particular circumstances. Various other modifications and changes will be apparent to those of ordinary skill.

1. An electronic publication advertising system comprising:
establishing sponsorship standards for reviewing advertisements for inclusion in an electronic publication;
reviewing at least one advertisement to determine whether the at least one advertisement complies with the sponsorship standards;
reviewing the electronic publication to determine a placement location of the at least one advertisement;
distributing the electronic publication with the at least one advertisement in the placement location; and
reviewing the electronic publication by a person affiliated with the use of the distributed electronic publication to determine if the at least one advertisement meets the sponsorship standards.

2. The electronic publication advertising system of claim 1, wherein the electronic publication is intended for a primary use in an educational setting.

3. The electronic publication advertising system of claim 1, wherein the electronic publication is provided in an internet browser-based format, an image-based format, a text-based format or combination thereof.

4. The electronic publication advertising system of claim 1, wherein the at least one advertisement comprises display, video, coupons, game, survey or combination thereof.

5. The electronic publication advertising system of claim 1, and further comprising:
obtaining information from the person affiliated with the use of the distributed electronic publication; and
using the information to select the at least one advertisement.

6. The electronic publication advertising system of claim 1, wherein persons who use the distributed electronic publication are not charged for the ability to use the distributed electronic publication.

7. The electronic publication advertising system of claim 1, wherein factors that may be considered in establishing the sponsorship standards include supporting diversity, gender equity, healthy behaviors, ethical conduct, academic standards, sexuality, morals, religion, health, safety, welfare and combinations thereof.

8. The electronic publication advertising system of claim 1, wherein sponsorship standards may include provisions on the amount, size and specific locations of the electronic publication where the at least one advertisement may be placed.

9. The electronic publication advertising system of claim 1, wherein reviewing the placement location comprises identifying a region of the electronic publication where the at least one advertisement may be placed, a permissible subject matter for the at least one advertisement, a type of the at least one advertisement or combination thereof.

10. The electronic publication advertising system of claim 1, wherein reviewing the placement location comprises assigning a comparative value to the placement location relative to other placement locations in the electronic publication.

11. The electronic publication advertising system of claim 10, wherein the person affiliated with the use of the distributed electronic publication is an administrator, an instructor, a student or combination thereof.

12. The electronic publication advertising system of claim 1, and further comprising issuing a certification status if the at least one advertisement attains satisfactory review by the person affiliated with the use of the distributed electronic publication.

13. The electronic publication advertising system of claim 12, wherein the certification status entitles the at least one advertisement to preferential advertising rates, preferential placement or combination thereof.

14. The electronic publication advertising system of claim 12, and further comprising including a reference to the certification status in the at least one advertisement.

15. The electronic publication advertising system of claim 12, and further comprising collecting data relating to responses received from the at least one advertisement.

16. The electronic publication advertising system of claim 1, and further comprising printing the distributed electronic publication to form a printed publication.

17. The electronic publication advertising system of claim 16, and further comprising:
distributing the printed publications in a plurality of sections; and
modifying the at least one advertisement based upon the review of the at least one advertisement from a prior section of the printed publication.

18. A printed publication advertising system comprising:
establishing sponsorship standards for reviewing advertisements for inclusion in an electronic publication;
reviewing at least one advertisement to determine whether the at least one advertisement complies with the sponsorship standards;
reviewing the printed publication to determine a placement location of the at least one advertisement;
printing the electronic publication to product a printed publication;
distributing the printed publication with the at least one advertisement in the placement location; and
reviewing the printed publication by a person affiliated with the use of the distributed printed publication to determine if the at least one advertisement meets the sponsorship standards.

19. The printed publication advertising system of claim 18, wherein the printed publication is intended for a primary use in an educational setting.

20. The printed publication advertising system of claim 18, wherein persons who use the distributed electronic publication are not charged for the ability to use the distributed electronic publication.
